(19) United States
(12) Patent Application Publication
(10) Pub. No.: US 2006/0098309 A1
(43) Pub. Date: May 11, 2006

(54) TOTAL INTERNAL REFLECTION PRISM AND SINGLE LIGHT VALVE PROJECTOR

(76) Inventors: S-Wei Chen, Hsinchu (TW); Chu-Ming Cheng, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,956

(22) Filed: Aug. 24, 2005

(30) Foreign Application Priority Data
Nov. 9, 2004 (TW) 93134060

(51) Int. Cl. G02B 5/04

(52) U.S. Cl. 359/833

(57) ABSTRACT

A total internal reflection (TIR) prism comprising a first prism, a second prism and an optical path compensation prism is provided. The first prism has a first light incident surface, a first light emitting surface and a total reflective surface. The second prism has a second light incident surface and a second light emitting surface. The total reflective surface of the first prism is connected to the second light incident surface of the second prism and an air gap is formed between the total reflective surface and the second light incident surface. The optical path compensation prism is disposed on the first light incident surface of the first prism or the second light emitting surface of the second prism. Besides, another TIR prism comprising a first prism and a second prism is also proposed. The first prism has a refractive index different from that of the second prism.

### CROSS-REFERENCE TO RELATED APPLICATION

This application claims the priority benefit of Taiwan application serial no. 93134060, filed on Nov. 9, 2004. All disclosure of the Taiwan application is incorporated herein by reference.

### BACKGROUND OF THE INVENTION

1. Field of the Invention

The present invention relates to a total internal reflection (TIR) prism. More particularly, the present invention relates to a total internal reflection (TIR) prism with optical path compensation capability.

2. Description of the Related Art

In recent years, large and bulky cathode ray tubes (CRT) have been gradually replaced by liquid crystal projectors and digital light processing (DLP) projectors. These projectors are light and have streamlined body for greater portability. Furthermore, these projectors can be directly connected to many types of digital products to display images. With various manufacturers simultaneously developing different kinds of cheap and highly competitive projectors and providing extra functions, the applications of projectors have been expanded into typical families beside companies, schools and other public places.

In a conventional projector with a single reflective light valve and a total internal reflection (TIR) prism, the TIR prism is deployed to reflect a light beam to a digital micro-mirror device (DMD). Through the DMD, the light beam is converted to an image.

FIG. 1 is a diagram showing the structural components inside a projector with a single reflective light valve. As shown in FIG. 1, the projector 100 with a single reflective light valve mainly includes an illumination system 110, a projection lens 120, a digital micro-mirror device (DMD) 130 and a total internal reflection (TIR) prism 140. The illumination system 110 has a light source 112. The light source 112 is suitable for providing a light beam 114. The projection lens 120 is disposed on the optical transmission path of the light beam 114. The projection lens 120 has an optical axis 122. The digital micro-mirror device 130 is disposed between the light source 110 and the projection lens 120 along the transmission path of the light beam 114. The digital micro-mirror device 130 has an active surface 132. A normal vector 132a of the active surface 132 is parallel to the optical axis 122. The total internal reflection prism 140 is disposed between the digital micro-mirror device 130 and the projection lens 120. Furthermore, the total internal reflection prism 140 includes a first prism 142 and a second prism 144.

The first prism 142 has a first light incident surface 142a, a first light emitting surface 142b and a total reflective surface 142c. The first prism 142 has a refractive index n. The second prism 144 has a second light incident surface 144a and a second light emitting surface 144b. The second prism 144 has a refractive index equal to the first prism. In addition, the total internal reflective surface 142c of the first prism 142 is connected to the second light incident surface 144a of the second prism 144 and an air gap 146 is formed between the total reflective surface 142c and the second light incident surface 144a.

In the aforementioned projector 100 with a single reflective light valve, the beam 114 provided by the light source 112 can be regarded as an array of light beams. The light beam 114 enters through the first light incident surface 142a into the first prism 142 and is transmitted to the total reflective surface 142c. Thereafter, the total reflective surface 142c reflects the light beam 114 to the first light emitting surface 142b. Then, the light beam 114 is transmitted to the digital micro-mirror device 130. The digital micro-mirror device 130 processes the light beam 114 and then the processed light beam (an image) 114 is transmitted to the first prism 142 again. The light beam 114 can pass through the total reflective surface 142c and the air gap 146 and enter the second prism 144 through the second light incident surface 144a, since there is a change in the incident angle of the light beam (the image) 114. After that, the light beam (the image) 114 entering the second prism 144 is transmitted through the second light emitting surface 144b to the projection lens 120.

FIGS. 2A and 2B are diagrams showing the image-forming techniques using different arrangement of total internal reflection prisms inside a conventional projector with a single reflective light valve. As shown in FIGS. 1, 2A and 2B, the light 114a and 114b of the light beam 114 inside the total internal reflection prism 140 have different path lengths. Hence, there is an optical path difference between the light 114a and 114b inside the total internal reflection prism 140 and leads to the inability of the light pattern 50 projected on the digital micro-mirror device (DMD) 130 to be a rectangular shape. As shown in FIG. 2A, when the DMD 130 is a diamond-shaped DMD, the light beam 114 enters the DMD 130 in a direction parallel to the long side 132 of the DMD 130 and is emitted from the DMD 130 in a direction parallel to the long side 132 of the DMD 130. Due to the optical path difference, the size of the focused light spots 52 on the DMD 130 is different. Therefore, the light pattern 50 on the DMD 130 appears as a trapezoidal shape and leads to deterioration of overall brightness and uniformity. In addition, as shown in FIG. 2B, when the DMD 130 is a normal DMD, the light beam 114 enters the DMD 130 at an angle of 45° relative to the long side 132 of the DMD 130 and is emitted from the DMD 130 at an angle of 45° relative to the long side 132 of the DMD 130. Due to the optical path difference, the size of focused light spots 52 on the DMD 130 is different. Hence, the light pattern 50 on the DMD 130 appears as a parallelogram and leads to deterioration of overall brightness and uniformity.

Moreover, in the conventional projector 100 with a single reflective light valve, a normal vector 132a perpendicular to the active surface 132 of the DMD 130 must be parallel to the optical axis 122 of the projection lens 120. This renders the optical paths of the light 114a and 114b being transmitted from the digital micro-mirror device 130 to the projection lens 120 identical and hence avoids the optical path difference.

### SUMMARY OF THE INVENTION

Accordingly, the present invention is directed to provide a total internal reflection prism capable of compensating optical path difference at an illuminating end of the prism. The present invention utilizes an optical path compensation prism disposed on a first light incident surface of the first prism of the total internal reflection prism or a second light emitting surface of a second prism to minimize or eliminate the optical path difference of a light beam, which is transmitted between the total internal reflection prism and a digital micro-mirror device.

The present invention is directed to provide a total internal reflection prism capable of compensating optical path difference through the difference in refractive indexes between a first prism and a second prism inside the total internal reflection prism. Thus, when a digital micro-mirror device and a projection lens are set not in parallel to each other, the optical path difference of a light beam projecting from the digital micro-mirror device to the projection lens is minimized or eliminated.

The present invention is directed to provide a projector with a single reflective light valve that utilizes the difference in the refractive indexes between a first prism and a second prism inside a total internal reflection prism, or an optical path compensation prism disposed on the first light incident surface of the first prism or the second light emitting surface of the second prism of the total internal reflection prism, to compensate optical path difference in the transmission of a light beam.

As embodied and broadly described herein, the invention provides a total internal reflection prism. The total internal reflection prism mainly includes a first prism, a second prism and an optical path compensation prism. The first prism has a first light incident surface, a firs light emitting surface and a total reflective surface. The second prism has a second light incident surface and a second light emitting surface. The total reflective surface of the first prism is connected to the second light incident surface of the second prism and an air gap is formed between the total reflective surface and the second light incident surface. The optical path compensation prism is disposed on the first light incident surface of the first prism or the second light emitting surface of the second prism.

In the aforementioned total internal reflection prism, the first prism can have a refractive index identical to that of the second prism or different from that of the second prism. In addition, the optical path compensation prism can have a refractive index identical to that of the first prism or different from that of the second prism. Furthermore, the optical path compensation prism and the first prism can be fabricated together as an integrative unit.

The present invention also provides an alternative total internal reflection prism. The total internal reflection prism mainly includes a first prism and a second prism. The first prism has a first light incident surface, a first light emitting surface and a total reflective surface. The first prism has a refractive index n1. The second prism has a second light incident surface and a second light emitting surface. The second prism has a refractive index n2 such that n2 is not equal to n1 (n2≠n1). The total reflective surface of the first prism is connected to the second light incident surface of the second prism and an air gap is formed between the total reflective surface and the second light incident surface.

The present invention also provides a projector with a single reflective light valve. The projector with a single reflective light valve mainly includes a light source, a projection lens, a reflective light valve and a total internal reflection prism. The light source is suitable for providing a light beam. The projection lens is disposed along the transmission path of the light beam. The projection lens has an optical axis. The reflective light valve is disposed between the light source and the projection lens along the transmission path of the light beam. The reflective light valve has an active surface, wherein a normal vector of the active surface is non-parallel to the optical axis. The total internal reflection prism is disposed between the reflective light valve and the projection lens. The total internal reflection prism is one of the aforementioned types of total internal reflection prisms.

In the aforementioned projector with a single reflective light valve, the reflective light valve is a digital micro-mirror device, for example.

In the present invention, a total internal reflection prism having an optical path compensation prism or a total internal reflection prism having a first prism and a second prism with different refractive indexes is used. Hence, there is very little optical path difference for a light beam passing through the total internal reflection prism. As a result, the light pattern on the digital micro-mirror device is very close to a rectangular shape and overall brightness and uniformity is improved. Furthermore, using a total internal reflection prism having a first prism and a second prism with different reflective indexes to compensate for the optical path difference in the transmission path of the light beam, the original resolution can be maintained without setting the active surface of the reflective light valve and the optical axis parallel to each other.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing the structural components inside a projector with a single reflective light valve.

FIGS. 2A and 2B are diagrams showing the image-forming techniques using different arrangement of total internal reflection prisms inside a conventional projector with a single reflective light valve.

FIG. 3 is a diagram showing the structure of a total internal reflection prism according to a first embodiment of the present invention.

FIG. 4 is a diagram showing the structure of a total internal reflection prism according to a second embodiment of the present invention.

FIG. 5 is a diagram showing the structure of a total internal reflection prism according to a third embodiment of the present invention.

FIG. 6 is a diagram showing the structure of a single reflective light valve projector according to a fourth embodiment of the present invention.

FIGS. 7A and 7B are diagrams showing the structures of another two single reflective light valve projector according to the fourth embodiment of the present invention.

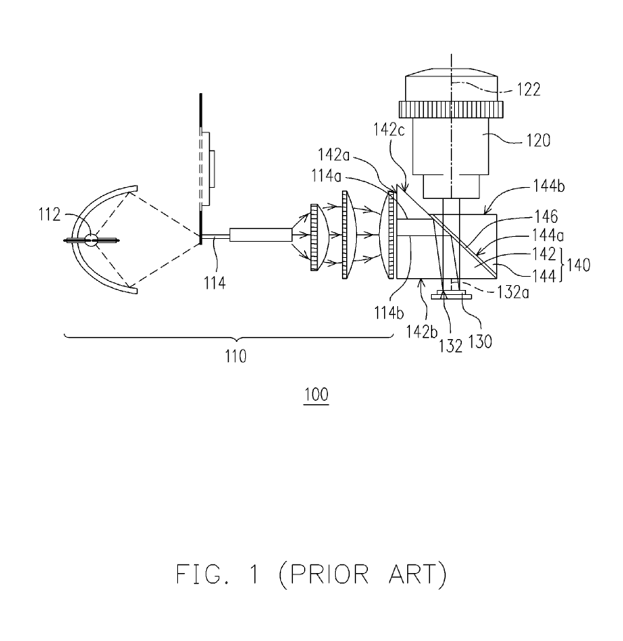

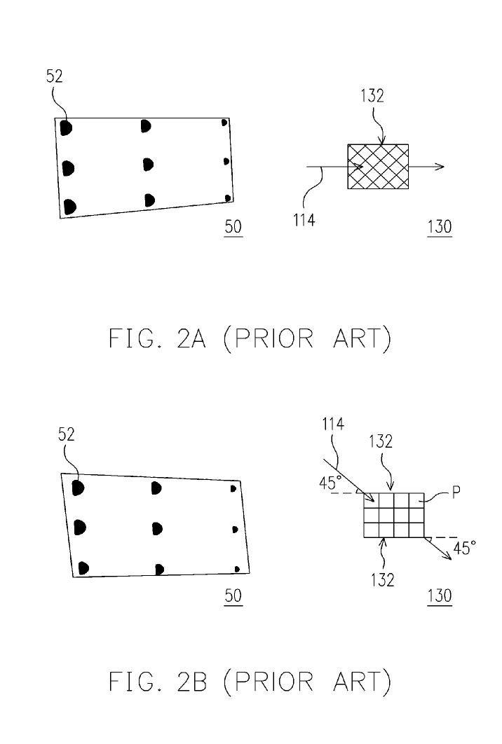

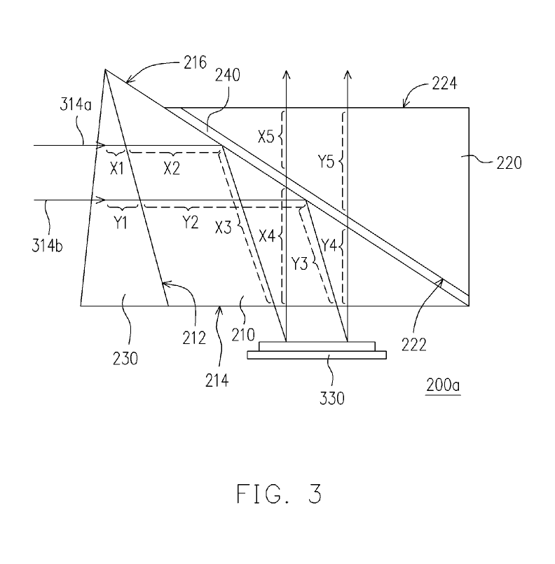

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 3 is a diagram showing the structure of a total internal reflection prism according to a first embodiment of the present invention. As shown in FIG. 3, the total internal reflection prism 200a of the present embodiment mainly includes a first prism 210, a second prism 220 and an optical path compensation prism 230. The first prism 210 has a first light incident surface 212, a first light emitting surface 214 and a total reflective surface 216. The second prism 220 has a second light incident surface 222 and a second light emitting surface 224. The total reflective surface 216 of the first prism 210 is connected to the second light incident surface 222 of the second prism 220 and an air gap 240 is formed between the total reflective surface 216 and the second light incident surface 222. The optical path compensation prism 230 is disposed on the first light incident surface 212 of the first prism 210.

In the aforementioned total internal reflection prism 200a, the light 314a and 314b passing through the optical path compensation prism 230 enters the first prism 210 through the first light incident surface 212 and then are transmitted to the total reflective surface 216. Thereafter, the total reflective surface 216 reflects the light 314a and 314b to the first light emitting surface 214. Then, the light 314a and 314b are transmitted to a reflective light valve 330. After processing procedure of the reflective light valve 330, the processed light (the sub-image) 314a and 314b are transmitted to the total reflective surface 216 of the first prism 210 again. Because the incident angles of the light (the sub-image) 314a and 314b into the total reflective surface 216 have already been changed, the light (the sub-image) 314a and 314b can pass through the total reflective surface 216 and the air gap 240 and enter the second prism 220 through the second light incident surface 222. Afterwards, the light (the sub-image) 314a and 314b entering the second prism 220 are emitted from the second prism 220 through the second light emitting surface 224.

In the aforementioned total internal reflection prism 200a, the first prism 210, the second prism 220 and the optical path compensation prism 230 can have a refractive index n1, n2 and n3 respectively. In addition, the total optical path lengths of the light 314a and 314b between the first prism 210 and the second prism 220 are different. In other words, the total optical path length (X2+X3+X4+X5) is not equal to the total optical path length (Y2+Y3+Y4+Y5).

In the first embodiment of the present invention, the optical path compensation prism 230 is used to reduce or eliminate the optical path difference of the light 314a and 314b inside the total internal reflection prism 200a. In other words, through the optical path compensation prism 230, the total optical paths of the respective light 314a and 314b inside the total internal reflection prism 200a are rendered the same. In the present embodiment, the refractive index n1 of the first prism 210 is identical to the refractive index n2 of the second prism 220. Furthermore, the refractive index n3 of the optical path compensation prism 230 is identical to the refractive index n1 of the first prism 210. In other words, n1=n2=n3. In this case, the cross-sectional thickness X1 and Y1 of the optical path compensation prism 230 can be changed to set the total optical path of the light 314a [n3*(X1+X2+X3+X4+X5)] equal to the total optical path of the light 314b [n3*(Y1+Y2+Y3+Y4+Y5)].

In addition, the refractive index n1 of the first prism 210 can be identical to the refractive index n2 of the second prism 220 while the refractive index n3 of the optical path compensation prism 230 is different from the refractive index n1 of the first prism 210. In other words, n1=n2≠n3. In this case, the optical path compensation prism 230 can be used to set the total optical path of the light 314a [n1*(X2+X3+X4+X5)+n3*X1] equal to the total optical path of the light 314b [n1*(Y2+Y3+Y4+Y5)+n3*Y1].

For the total internal reflection prism 200a in the first embodiment of the present invention, the refractive index n1 of the first prism 210 can be different from the refractive index n2 of the second prism 220. Yet, the refractive index n3 of the optical path compensation prism 230 is identical to the refractive index n1 of the first prism 210. In other words, n1=n3≠n2. In this case, the optical path compensation prism 230 can be used to set the total optical path of the light 314a [n3*(X1+X2+X3+X4)+n2*X5] equal to the total optical path of the light 314b [n3*(Y1+Y2+Y3+Y4)+n2*Y5].

Furthermore, the refractive index n1 of the first prism 210, the refractive index of the second prism 220 and the refractive index of the optical path compensation prism 230 can all be different. In other words, n1≠n2≠n3. In this case, the optical path compensation prism 230 can be used to set the total optical path of the light 314a [n1*(X2+X3+X4)+n2*X5+n3*X1] equal to the total optical path of the light 314b [n1*(Y2+Y3+Y4)+n2*Y5+n3*Y1]. In the present embodiment, the total optical paths of the light 314a and 314b within the total internal reflection prism 200a are identical. Hence, it does not matter which type of arrangement is actually used for the reflective light valve 330, the optical path difference can be compensated through changing the thickness of the optical path compensation prism 230 or changing the refractive index of various prisms. Ultimately, the light pattern on the digital micro-mirror device is close to rectangular so that a brighter and more uniform projected image is produced.

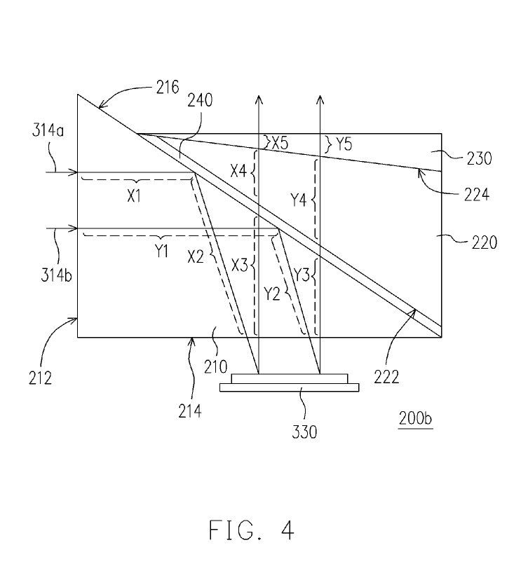

FIG. 4 is a diagram showing the structure of a total internal reflection prism according to a second embodiment of the present invention. As shown in FIG. 4, the total internal reflection prism 200b of the present embodiment mainly includes a first prism 210, a second prism 220 and an optical path compensation prism 230. The first prism 210 has a first light incident surface 212, a first light emitting surface 214 and a total reflective surface 216. The second prism 220 has a second light incident surface 222 and a second light emitting surface 224. The total reflective surface 216 of the first prism 210 is connected to the second light incident surface 222 of the second prism 220 and an air gap 240 is formed between the total reflective surface 216 and the second light incident surface 222. The optical path compensation prism 230 is disposed on the second light emitting surface 224 of the second prism 220.

In the aforementioned total internal reflection prism 200b, the light 314a and 314b enter the first prism 210 through the first light incident surface 212 and then travel to the total reflective surface 216. Thereafter, the total reflective surface 216 reflects the light 314a and 314b to the first light emitting surface 214. Then, the light 314a and 314b travel to a reflective light valve 330. After some processing inside the reflective light valve 330, the processed light (the sub-image) 314a and 314b are transmitted to the total reflective surface 216 of the first prism 210 again. Because the angles of incident of the light (the sub-image) 314a and 314b into the total reflective surface 216 have already been changed, it can pass through the total reflective surface 216 into the air gap 240 and enter the second prism 220 through the second light incident surface 222. Afterwards, the light (the sub-image) 314a and 314b are emitted from the second light emitting surface 224 of the second prism 220 to enter the optical path compensation prism 230.

In the aforementioned total internal reflection prism 200b, the first prism 210, the second prism 220 and the optical path compensation prism 230 can have a refractive index n1, n2 and n3 respectively. In addition, the total optical path lengths of the light 314a and 314b between the first prism 210 and the second prism 220 are different. In other words, the total optical path length (X3+X4) is not equal to the total optical path length (Y3+Y4).

In the second embodiment of the present invention, the optical path compensation prism 230 is used to reduce the optical path difference of the light 314a and 314b inside the total internal reflection prism 200b. In other words, through the optical path compensation prism 230, the total optical paths of the respective light 314a and 314b inside the total internal reflection prism 200b are rendered the same. In the present embodiment, the refractive index n1 of the first prism 210 is identical to the refractive index n2 of the second prism 220. Furthermore, the refractive index n3 of the optical path compensation prism 230 is identical to the refractive index n1 of the first prism 210. In other words, n1=n2=n3. In this case, the cross-sectional thickness X5 and Y5 of the optical path compensation prism 230 can be changed to set the total optical path of the light 314a [n3*(X3+X4+X5)] equal to the total optical path of the light 314b [n3*(Y3+Y4+Y5)].

In addition, the refractive index n3 of the optical path compensation prism 230 can be different from the refractive index n1 of the first prism 210. In other words, n1=n2≠n3. In this case, the optical path compensation prism 230 can be used to set the total optical path of the light 314a [n1*(X3+X4)+n3*X5] equal to the total optical path of the light 314b [n1*(Y3+Y4)+n3*Y5].

For the total internal reflection prism 200b in the second embodiment of the present invention, the refractive index n1 of the first prism 210 can be different from the refractive index n2 of the second prism 220. Yet, the refractive index n3 of the optical path compensation prism 230 is identical to the refractive index n1 of the first prism 210. In other words, n1=n3≠n2. In this case, the optical path compensation prism 230 can be used to set the total optical path of the light 314a [n3*(X3+X5)+n2*X4] equal to the total optical path of the light 314b [n3*(Y3+Y5)+n2*Y4].

Furthermore, the refractive index n3 of the optical path compensation prism 230 can be different from the refractive index n2 of the first prism 210. In other words, n1≠n2≠n3. In this case, the optical path compensation prism 230 can be used to set the total optical path of the light 314a (n1*X3+n2*X4+n3*X5) equal to the total optical path of the light 314b (n1*Y3+n2*Y4+n3*Y5).

In the present embodiment, the total optical paths of the light 314a and 314b within the total internal reflection prism 200b are identical. Hence, it does not matter if the reflective light valve 330 is perpendicular to the optical axis or is in parallel to the incident surface of the projection lens, the original resolution of the projected image can be maintained.

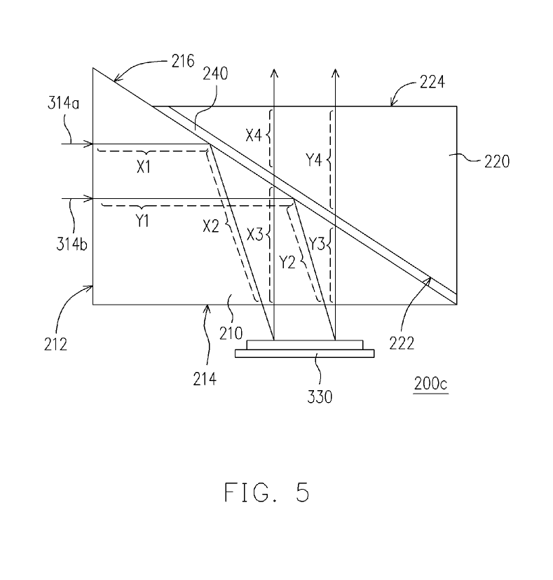

FIG. 5 is a diagram showing the structure of a total internal reflection prism according to a third embodiment of the present invention. As shown in FIG. 5, the total internal reflection prism 200c of the present embodiment mainly includes a first prism 210 and a second prism 220. The first prism 210 has a first light incident surface 212, a first light emitting surface 214 and a total reflective surface 216. The first prism 210 has a refractive index n1. The second prism 220 has a second light incident surface 222 and a second light emitting surface 224. The second prism 220 has a refractive index n2 such that n2≠n1. The total reflective surface 216 of the first prism 210 is connected to the second light incident surface 222 of the second prism 220 and an air gap 240 is formed between the total reflective surface 216 and the second light incident surface 222.

In the aforementioned total internal reflection prism 200c, the light 314a and 314b enter the first prism 210 through the first light incident surface 212 and then travel to the total reflective surface 216. Thereafter, the total reflective surface 216 reflects the light 314a and 314b to the first light emitting surface 214. Then, the light 314a and 314b travel to a reflective light valve 330. After some processing inside the reflective light valve 330, the processed light (the sub-image) 314a and 314b are transmitted to the total reflective surface 216 of the first prism 210 again. Because the angles of incident of the light (the sub-image) 314a and 314b into the total reflective surface 216 have already been changed, it can pass through the total reflective surface 216 into the air gap 240 and enter the second prism 220 through the second light incident surface 222. Afterwards, the light (the sub-image) 314a and 314b are emitted from the second light emitting surface 224 of the second prism 220.

In the aforementioned total internal reflection prism 200c, the first prism 210 and the second prism 220 have a refractive index n1 and n2 respectively. In addition, the total optical path lengths of the light 314a and 314b between the first prism 210 and the second prism 220 are different. In other words, the total optical path length (X3+X4) is not equal to the total optical path length (Y3+Y4).

In the third embodiment of the present invention, the difference in the refractive indexes between the first prism 210 and the second prism 220 is utilized to minimize the optical path difference of the light 314a and 314b inside the total internal reflection prism 220c. In other words, by using material of different refractive index to form the first prism 210 and the second prism 220, the total optical path of the light 314a (n1*X3+n2*X4) is equal to the total optical path of the light 314b (n1*Y3+n2*Y4).

In the present embodiment, the total optical path of the light s 314a and 314b inside the total internal reflection prism 200c are identical. Therefore, it does not matter if the reflective light valve 330 is perpendicular to the optical axis or the reflective light valve 330 is parallel to the incident surface of the projection lens, the projected image can maintain the original resolution.

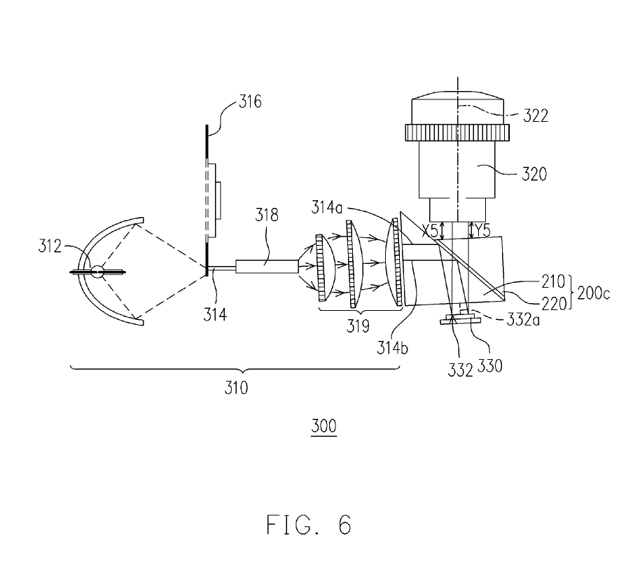

FIG. 6 is a diagram showing the structure of a projector with a single reflective light valve according to a fourth embodiment of the present invention. As shown in FIGS. 5 and 6, the present embodiment provides a projector 300 with a single reflective light valve. The projector 300 with a single reflective light valve mainly includes an illumination system 310, a projection lens 320, a reflective light valve 330 and a total internal reflection prism 200c. The illumination system 310 has a light source 312. The light source 312 is suitable for providing a light beam 314. The projection lens 320 is disposed along the transmission path of the light beam 314 and has an optical axis 322. The reflective light valve 330 is a digital micro-mirror device, for example, disposed between the light source 312 and the projection lens 320 along the transmission path of the light beam 314. The reflective light valve 330 also has an active surface 332, wherein a normal vector 332a is non-parallel to the optical axis 322. In addition, the total internal reflection prism 200c is disposed between the reflective light valve 330 and the projection lens 320. Since the internal structure of the total internal reflection prism 200c is similar to the one described in the third embodiment, a detailed description is omitted.

In the fourth embodiment of the present invention, the light beam 314 provided by the light source 312 passes through a color wheel 316, a light integration rod 318 and a relay lens 319 in sequence. Then, the total internal reflection prism 200c reflects the light beam 314 to the digital micro-mirror device 330. Thereafter, the digital micro-mirror device 330 converts the light beam 314 into an image and projects the image onto a screen (not shown) via the projection lens 320.

In some circumstances, perhaps due to some structural problems, a normal vector 332a of the active surface 332 of the reflective light valve 330 may not be aligned with the optical axis 322. Thus, the total length of the transmission path of the light beam 314 inside the total internal reflection prism 200c is not equal. Furthermore, the total path length of the light beam 314 from the total internal reflection prism 200c to the projection lens 320 may not be equal. Yet, the present embodiment is able to minimize the optical path difference of the light beam 314 by setting the first prism 210 and the second prism 220 inside the total internal reflection prism 200c to have different refractive indexes. For example, in the present embodiment, the difference in refractive indexes between the first prism 210 and the second prism 220 can be utilized to set the total optical path (n1*X3+n2*X4+n3*X5) of a light 314a of the light beam 314 equal to the total optical path (n1*Y3+n2*Y4+n3*Y5) of another light 314b of the light beam 314. Here, n3 is the refractive index of air. Hence, it does not matter if the reflective light valve 330 is perpendicular to the optical axis or is in parallel to the incident surface of the projection lens, the original resolution of the projected image can be maintained.

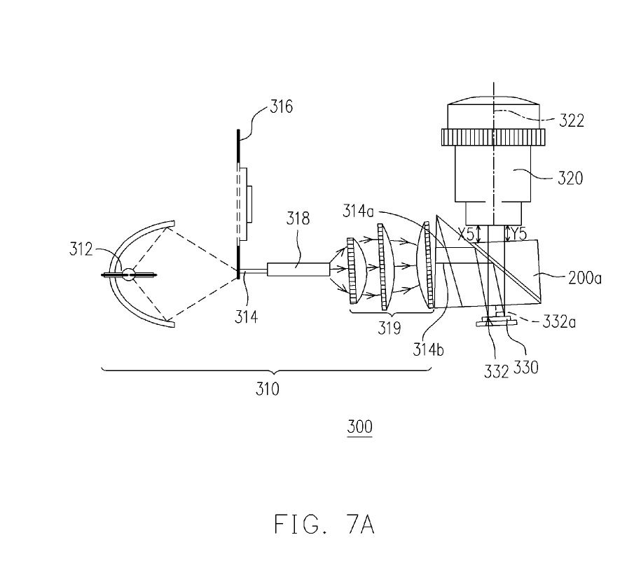

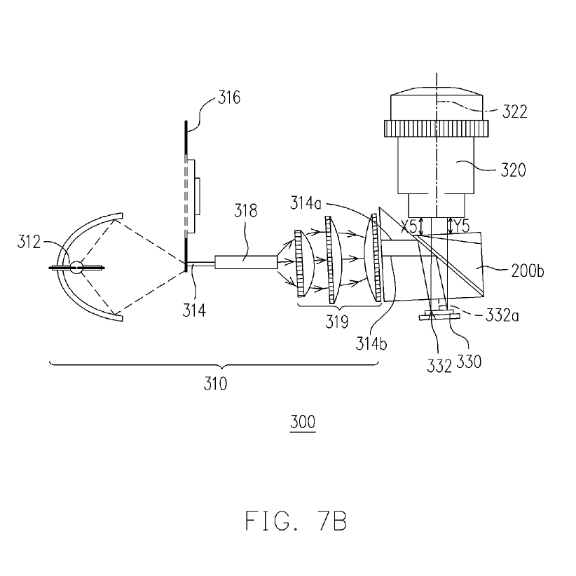

FIGS. 7A and 7B are diagrams showing the structures of another two projectors with a single reflective light valve according to the fourth embodiment of the present invention. The drawings in FIGS. 7A and 7B are very similar to the one in FIG. 6 except that the total internal reflection prism 200a shown in FIG. 3 is deployed in FIG. 7A and the total internal reflection prism 200b shown in FIG. 4 is deployed in FIG. 7B. Since the method of compensating the optical path difference through the total internal reflection prisms 200a and 200b is similar to the aforesaid, a detailed description is omitted.

In summary, the present invention utilizes a total internal reflection prism having an optical path compensation prism or a total internal reflection prism having a first prism and a second prism with different refractive indexes to minimize the optical path difference of a light beam inside the total internal reflection prism. Hence, the projected image can be brighter and more uniform or the resolution of the image can be maintained. In addition, the total internal reflection prism having a first prism and a second prism of difference refractive indexes can be used to compensate for the optical path difference in the transmission path of the light beam. Therefore, even if a normal vector of the active surface of the reflective light valve cannot be aligned with the optical axis of the projection lens due to some structural problems, the projector with a single reflective light valve of the present invention can still maintain the original image resolution.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A total internal reflection prism, comprising:
a first prism having a first light incident surface, a first light emitting surface and a total reflective surface;
a second prism having a second light incident surface and a second light emitting surface, wherein the total reflective surface is connected to the second light incident surface and an air gap is formed between the total reflective surface and the second light incident surface; and
an optical path compensation prism disposed on the first light incident surface.

2. The total internal reflection prism of claim 1, wherein the first prism has a refractive index identical to a refractive index of the second prism.

3. The total internal reflection prism of claim 1, wherein the optical path compensation prism has a refractive index identical to a refractive index of the first prism.

4. The total internal reflection prism of claim 2, wherein the optical path compensation prism has a refractive index different from the refractive index of the first prism.

5. The total internal reflection prism of claim 1, wherein the first prism has a refractive index different from a refractive index of the second prism.

6. The total internal reflection prism of claim 5, wherein the optical path compensation prism has a refractive index identical to the refractive index of the first prism.

7. The total internal reflection prism of claim 5, wherein the optical path compensation prism has a refractive index different from the refractive index of the first prism.

8. A total internal reflection prism, comprising:
a first prism having a first light incident surface, a first light emitting surface and a total reflective surface;
a second prism having a second light incident surface and a second light emitting surface, wherein the total reflective surface is connected to the second light incident surface and an air gap is formed between the total reflective surface and the second light incident surface; and
an optical path compensation prism disposed on the second light emitting surface.

9. The total internal reflection prism of claim 8, wherein the first prism has a refractive index identical to a refractive index of the second prism.

10. The total internal reflection prism of claim 9, wherein the optical path compensation prism has a refractive index identical to the refractive index of the first prism.

11. The total internal reflection prism of claim 9, wherein the optical path compensation prism has a refractive index different from the refractive index of the first prism.

12. The total internal reflection prism of claim 8, wherein the first prism has a refractive index different from a refractive index of the second prism.

13. The total internal reflection prism of claim 12, wherein the optical path compensation prism has a refractive index identical to the refractive index of the first prism.

14. The total internal reflection prism of claim 12, wherein the optical path compensation prism has a refractive index different from the refractive index of the first prism.

15. A total internal reflection prism, comprising:
a first prism having a first light incident surface, a first light emitting surface and a total reflective surface, wherein the first prism has a refractive index n1; and
a second prism having a second light incident surface and a second light emitting surface, wherein the second prism has a refractive index n2 such that n2≠n1, and the total reflective surface is connected to the second light incident surface and an air gap is formed between the total reflective surface and the second light incident surface.

16. A projector with a single reflective light valve, the projector comprising:
a light source suitable for providing a light beam;
a projection lens disposed along a transmission path of the light beam, wherein the projection lens has an optical axis;
a reflective light valve disposed between the light source and the projection lens along the transmission path of the light beam, wherein the reflective light valve has an active surface, wherein a normal vector of the active surface is not aligned in parallel to the optical axis;
a total internal reflection prism disposed between the reflective light valve and the projection lens, the total internal reflection prism comprising:
a first prism having a first light incident surface, a first light emitting surface and a total reflective surface, wherein the first prism has a refractive index n1; and
a second prism having a second light incident surface and a second light emitting surface, wherein the second prism has a refractive index n2 such that n2≠n1 and the total reflective surface is connected to the second light incident surface and an air gap is formed between the total reflective surface and the second light incident surface.

17. The projector with a single reflective light valve of claim 16, wherein the reflective light valve comprises a digital micro-mirror device.

18. A projector with a single reflective light valve, the projector comprising:
a light source suitable for providing a light beam;
a projection lens disposed along a transmission path of the light beam, wherein the projection lens has an optical axis;
a reflective light valve disposed between the light source and the projection lens along the transmission path of the light beam;
a total internal reflection prism disposed between the reflective light valve and the projection lens, the total internal reflection prism comprising:
a first prism having a first light incident surface, a first light emitting surface and a total reflective surface;
a second prism having a second light incident surface and a second light emitting surface, wherein the total reflective surface is connected to the second light incident surface and an air gap is formed between the total reflective surface and the second light incident surface; and
an optical path compensation prism disposed on the first light incident surface.

19. A projector with a single reflective light valve, the projector comprising:
a light source suitable for providing a light beam;
a projection lens disposed along a transmission path of the light beam, wherein the projection lens has an optical axis;
a reflective light valve disposed between the light source and the projection lens along the transmission path of the light beam;
a total internal reflection prism disposed between the reflective light valve and the projection lens, the total internal reflection prism comprising:
a first prism having a first light incident surface, a first light emitting surface and a total reflective surface;
a second prism having a second light incident surface and a second light emitting surface, wherein the total reflective surface is connected to the second light incident surface and an air gap is formed between the total reflective surface and the second light incident surface; and
an optical path compensation prism disposed on the second light emitting surface.
